(19) United States
(12) Patent Application Publication
(10) Pub. No.: US 2026/0037675 A1
(43) Pub. Date: Feb. 5, 2026

(54) PROVIDING METADATA FOR RENDERING FEATURES USING A DATABASE SYSTEM

(71) Applicant: Salesforce, Inc., San Francisco, CA (US)

(72) Inventors: James R. Morrin, JR., San Francisco, CA (US); Matthew Heitz, San Francisco, CA (US); Jonathon Powell, San Francisco, CA (US); Aayushi Bhargava, Jaipur (IN)

(73) Assignee: Salesforce, Inc., San Francisco, CA (US)

(21) Appl. No.: 18/789,367

(22) Filed: Jul. 30, 2024

(51) Int. Cl. G06F 21/62

(52) U.S. Cl. CPC G06F 21/629

(57) ABSTRACT

A database storing metadata describing a plurality of features may be maintained in association with a computing system implemented via a database system. The metadata may be processable to cause the features to be rendered in a plurality of different user experiences. A user interface may be displayed on a device of an authorized administrator affiliated with an organization implementing the computing system. The user interface May be associated with a first one of the different user experiences, The user interface may be configurable to allow the authorized administrator to enable a plurality of sets of features on behalf of the organization. A request a request to enable a first set of features from the plurality of sets of features may be received. The first set of features may be caused to be enabled for users associated with the organization.

### FIELD OF TECHNOLOGY

This patent document relates generally to on-demand software applications, and more specifically to providing metadata for rendering features using a database system.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks.

For example, such cloud computing services may be implemented via computing system which may be provided across a variety of user experiences. Such a computing system may have many features which may not be set up uniformly across these user experiences.

### BRIEF DESCRIPTION OF THE DRAWINGS

The included drawings are for illustrative purposes and serve only to provide examples of possible structures and operations for the disclosed inventive systems, apparatus, methods and computer program products for providing metadata for rendering features using a database system. These drawings in no way limit any changes in form and detail that may be made by one skilled in the art without departing from the spirit and scope of the disclosed implementations.

FIG. 1 illustrates an example of a method for providing metadata for rendering features using a database system, in accordance with one or more implementations.

FIG. 2 shows a block diagram of an example of a feature configuration system, in accordance with some implementations.

FIGS. 3-6 show examples of Graphical User Interfaces (GUIs), in accordance with some implementations.

FIG. 7 shows a block diagram of an example of an environment that includes an on-demand database service configured in accordance with some implementations.

FIG. 8A shows a system diagram of an example of architectural components of an on-demand database service environment, configured in accordance with some implementations.

FIG. 8B shows a system diagram further illustrating an example of architectural components of an on-demand database service environment, in accordance with some implementations.

FIG. 9 illustrates one example of a computing device.

### DETAILED DESCRIPTION

Some implementations of the disclosed systems, apparatus, methods, and computer program products are configurable to provide metadata for rendering features using a database system. Such “features” may include any component of a cloud-based or non-cloud-based computing system. As described in detail below, the disclosed techniques may be implemented alone or in association with any type of computing system(s), such as a Customer Relationship Management (CRM) Platform, a social networking system, any type of consumer or business software, etc. While CRM platforms (such as those provided by Salesforce®, Inc.) are discussed herein as an example of such a computing system, one having skill in the art can appreciate that the examples of computing systems described herein may be replaced with any suitable substitutes, such as those described above.

One having skill in the art may appreciate that the techniques disclosed herein may be practiced during the setup experience for features. Such a setup experience may be different from runtime or end user facing behavior and rendering of features. Also or alternatively, the disclosed techniques may be practiced in other feature configuration environments beyond the setup experience.

Traditionally, end users can find it difficult to set up features in a large-scale computing system. In conventional systems, the setup experience can differ and may not be reproduceable across user experiences. By way of example, Measure for Measure Health is a comprehensive healthcare provider offering patients integrated care across specialties. Measure for Measure Health uses a conventional computing system to implement both their mobile and web applications. The computing system introduces a new messaging feature. Measure for Measure Health wishes to enable the new messaging feature for their mobile and web applications. Unfortunately, in the computing system, the feature set up process for the web application is completely different from the feature set up process for the mobile application. Furthermore, features are rendered based on completely different underlying data in the mobile application compared to the web application. As such, Measure for Measure Health is only able to set up the new messaging feature in their mobile application and not in their web application. This result leads to patient and provider confusion in utilizing both applications and poorer health outcomes for many individuals.

By contrast, using the disclosed techniques, features may be described by consistent metadata and implemented via common interfaces. As such, a standardized setup process may occur across user experiences. Returning to the above example, Measure for Measure Health employs a computing platform that uses the disclosed techniques to implement both their mobile application and their web application. In this scenario, while features may be rendered differently across user experiences, the underlying metadata by which the features are rendered may be consistent across both user experiences. Therefore, when the new messaging feature is introduced, Measure for Measure Health is presented with a clear and consistent set up experience across the mobile application and web application. As a result, the feature is set up correctly, and can be rendered in all available user experiences. From a user perspective, the messaging feature is quickly adopted by patients and providers alike, creating better communication between providers and patients along with improved health outcomes.

In some implementations, the disclosed techniques may leverage artificial intelligence (AI) such that pertinent features may be automatically recommended. Returning to the above example, Isabella is an authorized administrator at Measure for Measure Health tasked with keeping the features in the Measure for Measure Health mobile application and web application up to date with the most recent features provided by the computing system. Unfortunately, the computing system provides thousands of features; therefore, working on her own, Isabella may miss important new features that could lead to better care and improved patient outcomes. Using the disclosed techniques, feature metadata may be processed by Large Language Models (LLMs) and other AI systems to recommend features and walk a user through the setup of these features based on needs and wants expressed by the organization with which the user is affiliated. By way of illustration, an AI system identifies the “Diagnostic Display” feature (a feature for displaying diagnostic test results in a clear and novel way) as being of potential interest to Measure for Measure Health. The feature is then recommended to Isabella by the computing system and adopted for the Measure for Measure Health mobile and web applications, allowing diagnostic test results to be safely released to patients automatically without needing any explanation or review by medical professionals.

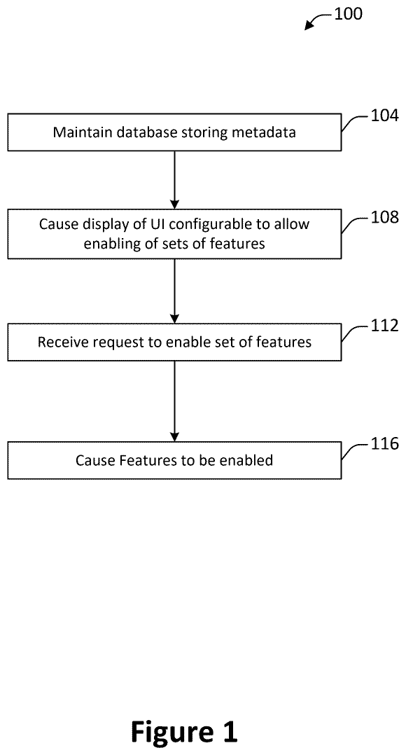

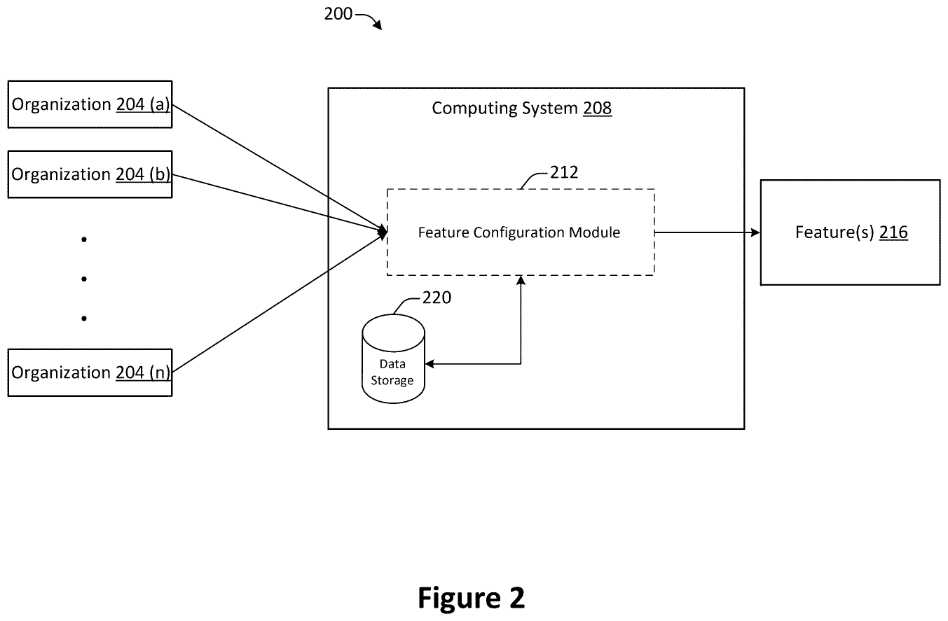

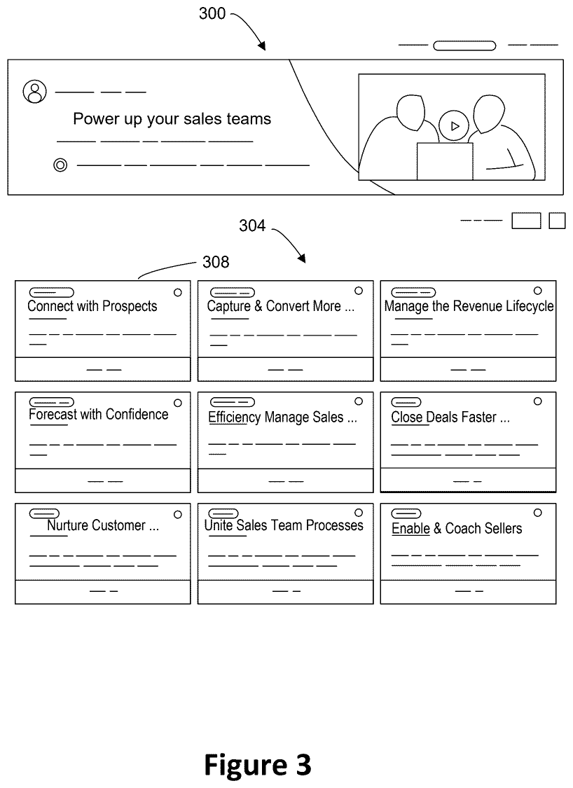

Referring now to the Figures, FIG. 1 illustrates an example of a method for providing metadata for rendering features using a database system, in accordance with one or more implementations. FIG. 1 is discussed in the context of FIGS. 2-6. FIG. 2 shows a block diagram of an example of a feature configuration system, in accordance with some implementations. FIGS. 3-6 show examples of Graphical User Interfaces (GUIs), in accordance with some implementations.

At 104 of FIG. 1, a database storing metadata is maintained. As discussed above, such metadata may describe features associated with a computing system. Such metadata may include a variety of information. For instance, the metadata corresponding to a feature may include capabilities, customization options, licensing information, and status of the feature.

The metadata corresponding to features may include a range of information and may vary across implementations. For example, the metadata corresponding to a particular feature may also include dependencies of the particular feature with respect to other features. By way of illustration, the proper function of the messaging feature described above requires the enablement of three additional features. Therefore, the messaging feature is “dependent” on the three additional features. Accordingly, the metadata of the messaging feature may indicate that the messaging feature is “dependent” on the three additional features. As such, when a user who has not enabled the three additional features tries to set up the messaging feature, the user may be notified by the computing system that she must enable the three additional features prior to setting up the messaging feature. Including dependency information in feature metadata may simplify the setup of multiple features by ensuring dependencies are configured in the correct order. Therefore, instead of a user simply relying on documentation, the computing system may help the user interactively at every step of the feature configuration and enablement process.

As discussed above, metadata may be processable to cause a corresponding feature to be rendered in different user experiences. Such user experiences may include any user experience by which a computing system is provided to users. By way of example, such user experiences may include a web application, a native mobile application, a hybrid application, an LLM chat interface, etc.

The database storing such metadata may be maintained in a variety of ways. For example, the database may be maintained via a computing system implemented using a database system. Such a computing system may be provided in a range of manners (e.g., via an on-demand computing services environment implemented using a database system and server system, as described below.) By way of example, in feature configuration environment 200 of FIG. 2, organizations 204(a)-(n) interact with computing system 208. As discussed above, the computing system 208 may be any type of computing system and may have a variety of components such as a CRM Platform, a social networking system, any type of consumer or business software, etc.

The computing system 208 includes a feature configuration module 212, which may perform the configuration techniques disclosed herein. As one having skill in the art can appreciate, “configuration” of a feature can describe a variety of actions such as setting up the feature, customizing the feature, enabling the feature, etc.

In some implementations, users affiliated with the organizations 204(a)-(n) may request configuration of feature(s) 216. The feature configuration module 212 may process such requests to generate such feature(s) 216. By way of example, Measure for Measure Health may use a CRM platform, such as one provided by Salesforce®, Inc. for configuration of their applications and/or web pages. The applications and/or web pages may be designable and/or customizable by authorized users affiliated with Measure for Measure Health. On behalf of Measure for Measure Health, Isabella may request configuration of a Measure for Measure Health messaging feature. In response to Isabella's request, as discussed below, the feature configuration module 212 may access data stored in data storage 220 on behalf of the Measure for Measure Health organization. The feature configuration module 212 may use this information, as well as information entered by Isabella into UIs of the computing system 208, to configure the Measure for Measure Health messaging feature.

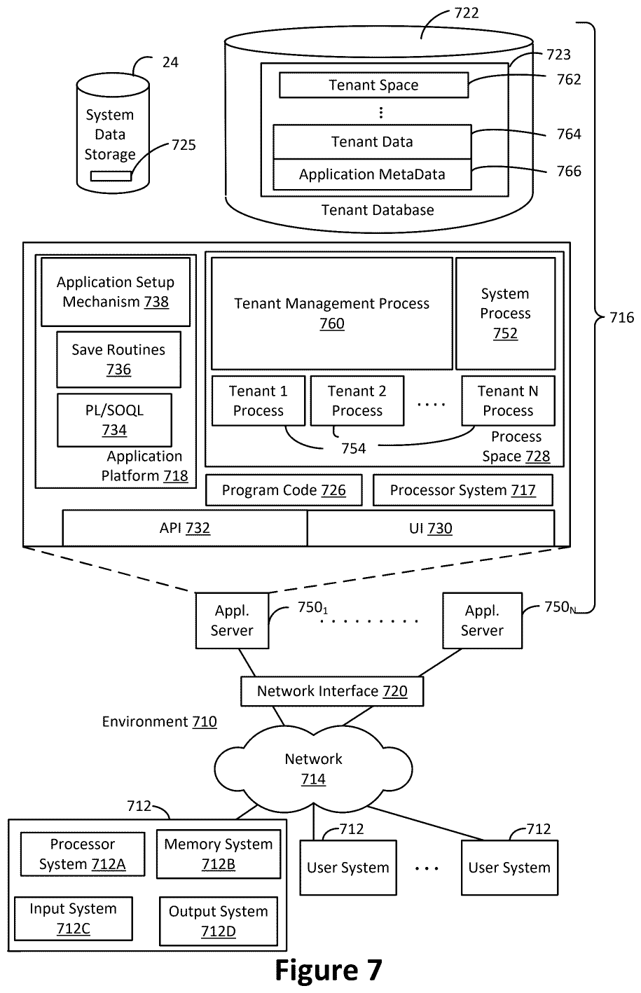

In some implementations, the computing system 208 may be provided to the organizations 204(a)-(n) via an on-demand computing environment, as discussed further below in the context of FIGS. 7-9. By way of example, the computing system 208 may be provided to the organizations 204(a)-(n) in a multi-tenant database system. In a similar configuration to FIG. 7, metadata may be stored in a database in data storage 220 of FIG. 2. The data storage 220 may store data of the organizations 204(a)-(n) in a multi-tenant architecture. The feature configuration module 212 may access the feature metadata stored in the data storage 220 a when a feature is configured. Similarly, the feature configuration module 212 may access (and the data storage 220 may store) other data relating to an organization 204(a)-(n) such as license status, branding information, etc.

Returning to the above example, the feature configuration module 212 may access metadata defining the messaging feature, which is stored in the data storage 220, when Isabella is configuring the messaging feature for Measure for Measure Health. Once Isabella has provided information via UIs of the computing system 208 to configure and enable the messaging feature for Measure for Measure Health, the feature configuration module 212 may cause the messaging feature to be configured and enabled in accordance with Isabella's instructions on behalf of Measure for Measure Health.

As discussed above, in some implementations, common interfaces and components may be used to render features across user experiences. By way of example, a variety of interface(s) may connect the device on which the feature(s) 216 are ultimately rendered, the metadata storage 220, the feature configuration module 212, and other components internal and external to the computing system 208. UI components may then be used to render the feature(s) 216 on the computing device. For instance, in a system provided by Salesforce®, Inc., standard Aura, lightning web components, and connect APIs may be used. In this example, Aura may be used to host a lightning web component-based setup experience and act as a bridge to get data from connect APIs via an Aura controller.

Returning to FIG. 1, at 108, a user interface is caused to be displayed on a device of an authorized administrator affiliated with an organization implementing the computing system. By way of example, user interface 300 of FIG. 3 may be displayed on Isabella's computing device.

Such a user interface may be associated with any user experience such as the user experiences described above. By way of example, the user interface 300 may be presented to Isabella via a web application of the computing system. Therefore, the user interface 300 may be rendered by a web browser on Isabella's computing device. Metadata may be accessed (e.g., metadata stored in the data storage 220 of FIG. 2) to allow information associated with features or sets of features to be displayed in the user interface 300. For instance, feature sets 304 of FIG. 3 may include sets of features that are available to Measure for Measure Health based on Measure for Measure Health's licenses in the computing system.

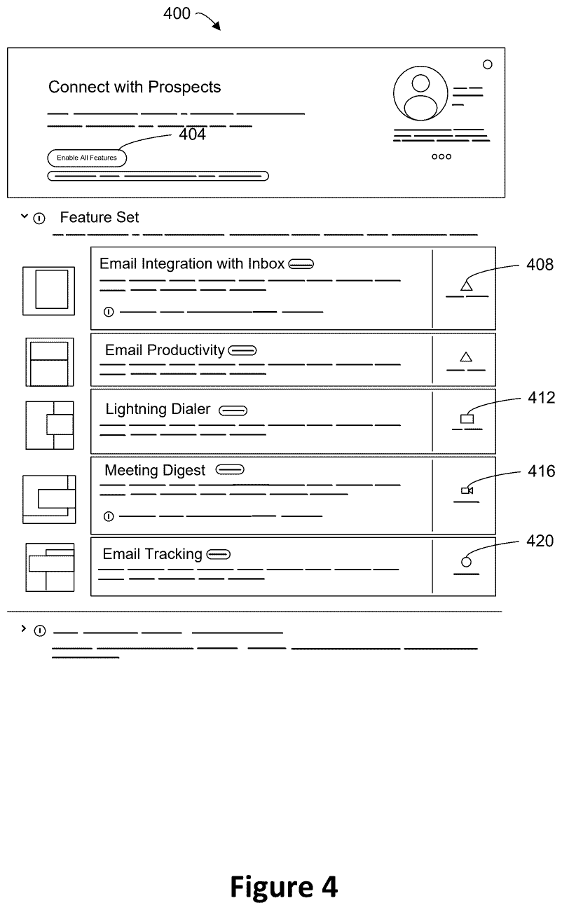

In some implementations, a user interface may be configurable to allow the authorized administrator to enable a plurality of sets of features on behalf of the organization. By way of example, Isabella may click or tap any of the feature sets 304 to begin the process of enabling and/or customizing features in each of the feature sets 304. For instance, Isabella may click or tap “Connect with Prospects” feature set 308. The computing system may then cause user interface 400 of FIG. 4 to be displayed on Isabella's computing device.

Returning to FIG. 1, at 112, a request to enable a first set of features is received from the authorized administrator. The request may be provided by the first user in a variety of manners, e.g. via user interface(s). By way of illustration, in the user interface 400 of FIG. 4, Isabella may click or tap “Enable All Features” button 404 to request to enable all features in the Connect with Prospects feature set.

Additionally, in some implementations, a user interface for enabling features may include a variety of other information. For example, in the user interface 400, Isabella may click or tap selection 408 to learn about the “Email Integration with Inbox” feature in a learning platform (e.g., Salesforce® Trailhead®), she may click or tap selection 412 to see a snapshot of the “Lightning Dialer” feature, she may click or tap selection 416 to see a demo video of the “Meeting Digest” feature, or she may click or tap selection 420 to take a tour of the “Email Tracking” feature. One having skill in the art can appreciate that a variety of other information may be displayed in a user interface such as usage information of features, suggestions of features to enable, etc.

Returning to FIG. 1, at 116, the first set of features is caused, based on the request of 112, to be enabled for users associated with the organization. By way of example, after Isabella clicks or taps the Enable All Features button 404 of FIG. 4, the computing system may cause the Connect with Prospects feature set to be enabled for all users affiliated with the Measure for Measure Health organization.

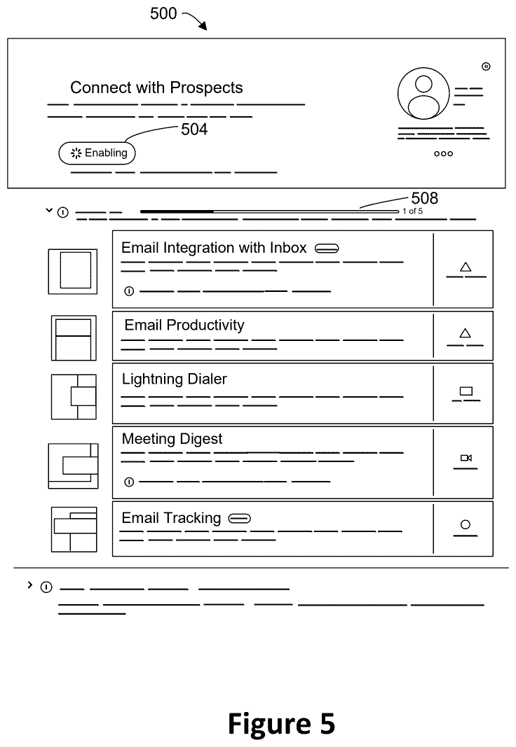

Since enabling complex sets of features for large organizations may take time, the Enable All Features button 404 of FIG. 4 may transform into “Enabling” notification 504 of FIG. 5 as displayed on Isabella's computing device in user interface 500. Progress bar 508 may indicate progress as features in the Connect with Prospects feature set are enabled by the computing system for users affiliated with the Measure for Measure Health organization. For example, the progress bar 508 indicates that one of the five features in the Connect with Prospects feature set has been enabled by the computing system for users affiliated with the Measure for Measure Health organization.

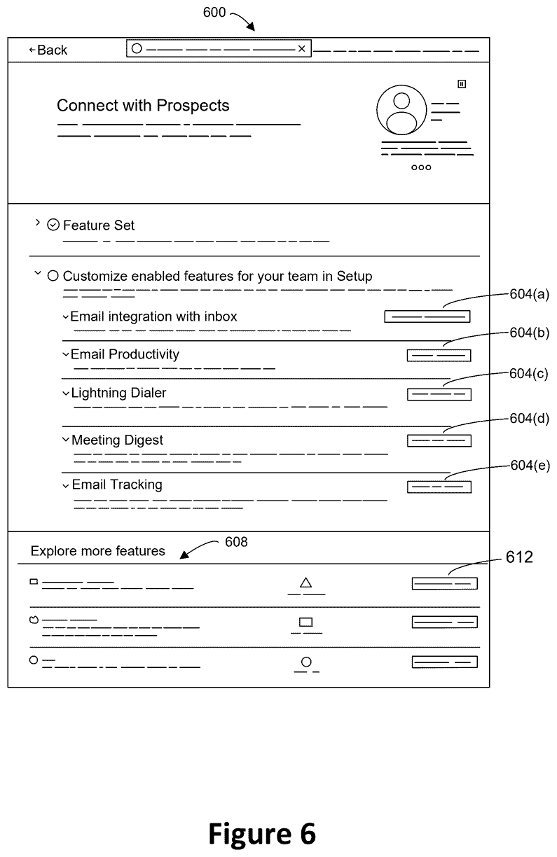

Once enablement of the features in the Connect with Prospects feature set is complete for users affiliated with the Measure for Measure Health organization, user interface 600 of FIG. 6 may be caused to be displayed on Isabella's computing device.

In some implementations, a variety of tasks may be accomplished once feature sets have been enabled. By way of illustration, Isabella may click or tap selections 604(a)-(e) to customize features in the Connect with Prospects feature set.

Window 608 may include recommended features or feature sets for Measure for Measure Health. In some implementations, such recommended features may require additional licenses which may be obtained via a user interface, e.g., by clicking or tapping selection 612.

In some implementations, features may be rendered in association with a variety of information. By way of example, the computing system may cause rendering of usage information of sets of features in association with the sets of features. As such, an administrator can see which features are being used more and which ones are being used less. The administrator can then disable or enable features accordingly and/or make sure users are made aware of under-utilized features.

Also or alternatively, such under-utilization may potentially indicate a mistake in configuration of features. Giving an authorized administrator visibility into usage information may facilitate the process of quickly identifying such mistakes. By way of example, Isabella inadvertently assigns the messaging feature to the wrong users in the Measure for Measure Health organization. As such, these users may simply ignore the feature since messaging isn't an important part of their job role. Since Isabella is closely viewing the usage information of the messaging feature, and sees that it is being under-utilized, she quickly notices her mistake and corrects it. By contrast, without access to usage information, quite a bit more time would have elapsed before Isabella became aware of her mistake.

In some implementations, related features may be composed into a setup flow automatically based on various attributes of an organization, the usage patterns of the organization's members, target markets for the organization's business, etc. By way of example, when Isabella configures features for Measure for Measure Health via the computing system, the computing system can cause automatic recommendation of a feature for securely sharing medical data across specialties. The feature may be automatically recommended based on fact that the Measure for Measure Health organization is focused on integrated care.

Also or alternatively, LLMs and other machine learning systems can consume feature usage data, metadata, feature implementation data, etc. for a variety of purposes. For example, an LLM chat interface may recommend features and walk users through the setup of the recommended features based on needs and wants expressed by the user and/or the organization with which the user is affiliated.

Additionally, as user experiences are updated, features may not need to be changed. By way of example, new user experiences may process existing metadata to be usable by the new user experience to cause features to be rendered in novel ways. By way of example, a messaging application, such as Slack, may be integrated with the computing platform. While features of the computing system may have been designed without the messaging application in mind, the messaging application may be able to process feature metadata such that these features may also be rendered by the messaging application.

In some implementations, feature setup may exist within help documentation. By way of illustration, a computing system's help documentation related to the computing system's lead conversion system may reference the metadata of the Connect with Prospects feature set 308 of FIG. 3. Therefore, a user interface to set up the Connect with Prospects feature set 308 may be included directly in the help documentation of the lead conversion system. A variety of other information such as a summary of utilization information of the Connect with Prospects feature set 308 may also be included.

One having skill in the art can appreciate that the disclosed techniques may be practiced in a variety of usage patterns across user experiences. By way of example, when a user is interacting with features or feature sets, they may typically complete their work within a given user experience. Alternatively, it would also be possible for the user to switch between user experiences. For instance, the user may commence set up of a feature set in one user experience and complete set up and/or configuration of the feature set in multiple steps across different user experiences.

FIG. 7 shows a block diagram of an example of an environment 710 that includes an on-demand database service configured in accordance with some implementations. Environment 710 may include user systems 712, network 714, database system 716, processor system 717, application platform 718, network interface 720, tenant data storage 722, tenant data 723, system data storage 724, system data 725, program code 726, process space 728, User Interface (UI) 730, Application Program Interface (API) 732, PL/SOQL 734, save routines 736, application setup mechanism 738, application servers 750-1 through 750-N, system process space 752, tenant process spaces 754, tenant management process space 760, tenant storage space 762, user storage 764, and application metadata 766. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 716, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 718 may be a framework that allows the creation, management, and execution of applications in system 716. Such applications may be developed by the database service provider or by users or third-party application developers accessing the service. Application platform 718 includes an application setup mechanism 738 that supports application developers' creation and management of applications, which may be saved as metadata into tenant data storage 722 by save routines 736 for execution by subscribers as one or more tenant process spaces 754 managed by tenant management process 760 for example. Invocations to such applications may be coded using PL/SOQL 734 that provides a programming language style interface extension to API 732. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 766 for a subscriber making such an invocation. Such system processes may also manage execution of application metadata 766 as an application in a virtual machine.

In some implementations, each application server 750 may handle requests for any user associated with any organization. A load balancing function (e.g., an F5 Big-IP load balancer) may distribute requests to the application servers 750 based on an algorithm such as least-connections, round robin, observed response time, etc. Each application server 750 may be configured to communicate with tenant data storage 722 and the tenant data 723 therein, and system data storage 724 and the system data 725 therein to serve requests of user systems 712. The tenant data 723 may be divided into individual tenant storage spaces 762, which can be either a physical arrangement and/or a logical arrangement of data. Within each tenant storage space 762, user storage 764 and application metadata 766 may be similarly allocated for each user. For example, a copy of a user's most recently used (MRU) items might be stored to user storage 764. Similarly, a copy of MRU items for an entire tenant organization may be stored to tenant storage space 762. A UI 730 provides a user interface and an API 732 provides an application programming interface to system 716 resident processes to users and/or developers at user systems 712.

System 716 may implement a web-based feature configuration system. For example, in some implementations, system 716 may include application servers configured to implement and execute feature configuration-related software applications. The application servers may be configured to provide related data, code, forms, web pages and other information to and from user systems 712. Additionally, the application servers may be configured to store information to, and retrieve information from a database system. Such information may include related data, objects, and/or Webpage content. With a multi-tenant system, data for multiple tenants may be stored in the same physical database object in tenant data storage 722, however, tenant data may be arranged in the storage medium(s) of tenant data storage 722 so that data of one tenant is kept logically separate from that of other tenants. In such a scheme, one tenant may not access another tenant's data, unless such data is expressly shared.

Several elements in the system shown in FIG. 7 include conventional, well-known elements that are explained only briefly here. For example, user system 712 may include processor system 712A, memory system 712B, input system 712C, and output system 712D. A user system 712 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 712 to access, process and view information, pages and applications available from system 716 over network 714. Network 714 may be any network or combination of networks of devices that communicate with one another, such as any one or any combination of a LAN (local area network), WAN (wide area network), wireless network, or other appropriate configuration.

The users of user systems 712 may differ in their respective capacities, and the capacity of a particular user system 712 to access information may be determined at least in part by “permissions” of the particular user system 712. As discussed herein, permissions generally govern access to computing resources such as data objects, components, and other entities of a computing system, such as an AI system, a social networking system, and/or a CRM database system. “Permission sets” generally refer to groups of permissions that may be assigned to users of such a computing environment. For instance, the assignments of users and permission sets may be stored in one or more databases of System 716. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 716 may provide on-demand database service to user systems 712 using an MTS arrangement. By way of example, one tenant organization may be a company that employs a sales force where each salesperson uses system 716 to manage their sales process. Thus, a user in such an organization may maintain contact data, leads data, customer follow-up data, performance data, goals and progress data, etc., all applicable to that user's personal sales process (e.g., in tenant data storage 722). In this arrangement, a user may manage his or her sales efforts and cycles from a variety of devices, since relevant data and applications to interact with (e.g., access, view, modify, report, transmit, calculate, etc.) such data may be maintained and accessed by any user system 712 having network access.

When implemented in an MTS arrangement, system 716 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 716 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 716 may also maintain system-level data usable by multiple tenants or other data. Such system-level data may include industry reports, news, postings, and the like that are sharable between tenant organizations.

In some implementations, user systems 712 may be client systems communicating with application servers 750 to request and update system-level and tenant-level data from system 716. By way of example, user systems 712 may send one or more queries requesting data of a database maintained in tenant data storage 722 and/or system data storage 724. An application server 750 of system 716 may automatically generate one or more SQL statements (e.g., one or more SQL queries) that are designed to access the requested data. System data storage 724 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

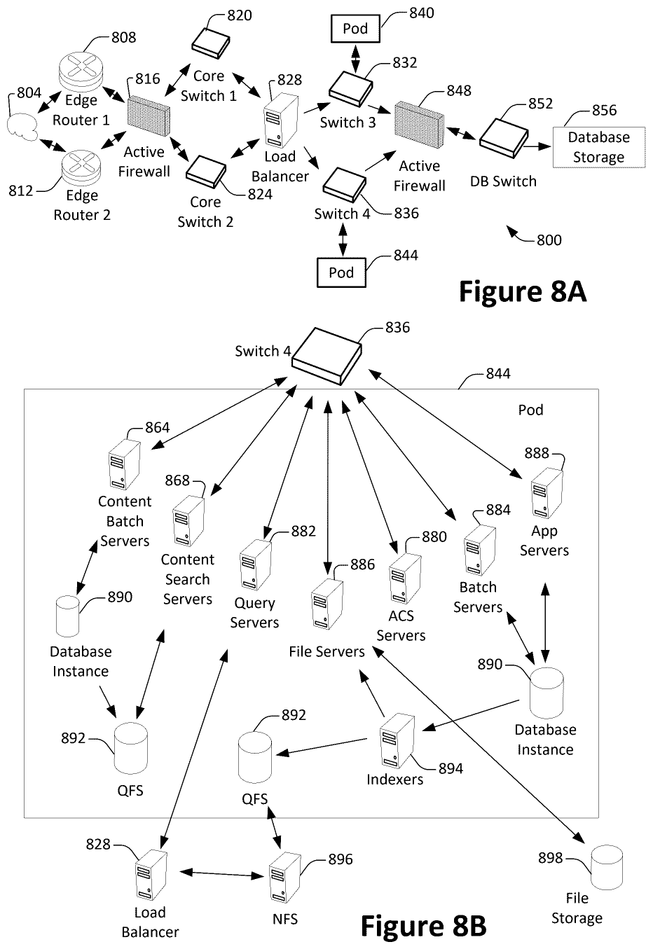

FIG. 8A shows a system diagram of an example of architectural components of an on-demand database service environment 800, configured in accordance with some implementations. A client machine located in the cloud 804 may communicate with the on-demand database service environment via one or more edge routers 808 and 812. A client machine may include any of the examples of user systems 712 described above. The edge routers 808 and 812 may communicate with one or more core switches 820 and 824 via firewall 816. The core switches may communicate with a load balancer 828, which may distribute server load over different pods, such as the pods 840 and 844 by communication via pod switches 832 and 836. The pods 840 and 844, which may each include one or more servers and/or other computing resources, may perform data processing and other operations used to provide on-demand services. Components of the environment may communicate with a database storage 856 via a database firewall 848 and a database switch 852.

Accessing an on-demand database service environment may involve communications transmitted among a variety of different components. The environment 800 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 8A and 8B.

The cloud 804 refers to any suitable data network or combination of data networks, which may include the Internet. Client machines located in the cloud 804 may communicate with the on-demand database service environment 800 to access services provided by the on-demand database service environment 800. By way of example, client machines may access the on-demand database service environment 800 to retrieve, store, edit, and/or process feature configuration information such as metadata described above.

In some implementations, the edge routers 808 and 812 route packets between the cloud 804 and other components of the on-demand database service environment 800. The edge routers 808 and 812 may employ the Border Gateway Protocol (BGP). The edge routers 808 and 812 may maintain a table of IP networks or ‘prefixes’, which designate network reachability among autonomous systems on the internet.

In one or more implementations, the firewall 816 may protect the inner components of the environment 800 from internet traffic. The firewall 816 may block, permit, or deny access to the inner components of the on-demand database service environment 800 based upon a set of rules and/or other criteria. The firewall 816 may act as one or more of a packet filter, an application gateway, a stateful filter, a proxy server, or any other type of firewall.

In some implementations, the core switches 820 and 824 may be high-capacity switches that transfer packets within the environment 800. The core switches 820 and 824 may be configured as network bridges that quickly route data between different components within the on-demand database service environment. The use of two or more core switches 820 and 824 may provide redundancy and/or reduced latency.

In some implementations, communication between the pods 840 and 844 may be conducted via the pod switches 832 and 836. The pod switches 832 and 836 may facilitate communication between the pods 840 and 844 and client machines, for example via core switches 820 and 824. Also or alternatively, the pod switches 832 and 836 may facilitate communication between the pods 840 and 844 and the database storage 856. The load balancer 828 may distribute workload between the pods, which may assist in improving the use of resources, increasing throughput, reducing response times, and/or reducing overhead. The load balancer 828 may include multilayer switches to analyze and forward traffic.

In some implementations, access to the database storage 856 may be guarded by a database firewall 848, which may act as a computer application firewall operating at the database application layer of a protocol stack. The database firewall 848 may protect the database storage 856 from application attacks such as structure query language (SQL) injection, database rootkits, and unauthorized information disclosure. The database firewall 848 may include a host using one or more forms of reverse proxy services to proxy traffic before passing it to a gateway router and/or may inspect the contents of database traffic and block certain content or database requests. The database firewall 848 may work on the SQL application level atop the TCP/IP stack, managing applications' connection to the database or SQL management interfaces as well as intercepting and enforcing packets traveling to or from a database network or application interface.

In some implementations, the database storage 856 may be an on-demand database system shared by many different organizations. The on-demand database service may employ a single-tenant approach, a multi-tenant approach, a virtualized approach, or any other type of database approach. Communication with the database storage 856 may be conducted via the database switch 852. The database storage 856 may include various software components for handling database queries. Accordingly, the database switch 852 may direct database queries transmitted by other components of the environment (e.g., the pods 840 and 844) to the correct components within the database storage 856.

FIG. 8B shows a system diagram further illustrating an example of architectural components of an on-demand database service environment, in accordance with some implementations. The pod 844 may be used to render services to user(s) of the on-demand database service environment 800. The pod 844 may include one or more content batch servers 864, content search servers 868, query servers 882, file servers 886, access control system (ACS) servers 880, batch servers 884, and app servers 888. Also, the pod 844 may include database instances 890, quick file systems (QFS) 892, and indexers 894. Some or all communication between the servers in the pod 844 may be transmitted via the switch 836.

In some implementations, the app servers 888 may include a framework dedicated to the execution of procedures (e.g., programs, routines, scripts) for supporting the construction of applications provided by the on-demand database service environment 800 via the pod 844. One or more instances of the app server 888 may be configured to execute all or a portion of the operations of the services described herein.

In some implementations, as discussed above, the pod 844 may include one or more database instances 890. A database instance 890 may be configured as an MTS in which different organizations share access to the same database, using the techniques described above. Database information may be transmitted to the indexer 894, which may provide an index of information available in the database 890 to file servers 886. The QFS 892 or other suitable filesystem may serve as a rapid-access file system for storing and accessing information available within the pod 844. The QFS 892 may support volume management capabilities, allowing many disks to be grouped together into a file system. The QFS 892 may communicate with the database instances 890, content search servers 868 and/or indexers 894 to identify, retrieve, move, and/or update data stored in the network file systems (NFS) 896 and/or other storage systems.

In some implementations, one or more query servers 882 may communicate with the NFS 896 to retrieve and/or update information stored outside of the pod 844. The NFS 896 may allow servers located in the pod 844 to access information over a network in a manner similar to how local storage is accessed. Queries from the query servers 822 may be transmitted to the NFS 896 via the load balancer 828, which may distribute resource requests over various resources available in the on-demand database service environment 800. The NFS 896 may also communicate with the QFS 892 to update the information stored on the NFS 896 and/or to provide information to the QFS 892 for use by servers located within the pod 844.

In some implementations, the content batch servers 864 may handle requests internal to the pod 844. These requests may be long-running and/or not tied to a particular customer, such as requests related to log mining, cleanup work, and maintenance tasks. The content search servers 868 may provide query and indexer functions such as functions allowing users to search through content stored in the on-demand database service environment 800. The file servers 886 may manage requests for information stored in the file storage 898, which may store information such as documents, images, basic large objects (BLOBs), etc. The query servers 882 may be used to retrieve information from one or more file systems. For example, the query system 882 may receive requests for information from the app servers 888 and then transmit information queries to the NFS 896 located outside the pod 844. The ACS servers 880 may control access to data, hardware resources, or software resources called upon to render services provided by the pod 844. The batch servers 884 may process batch jobs, which are used to run tasks at specified times. Thus, the batch servers 884 may transmit instructions to other servers, such as the app servers 888, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

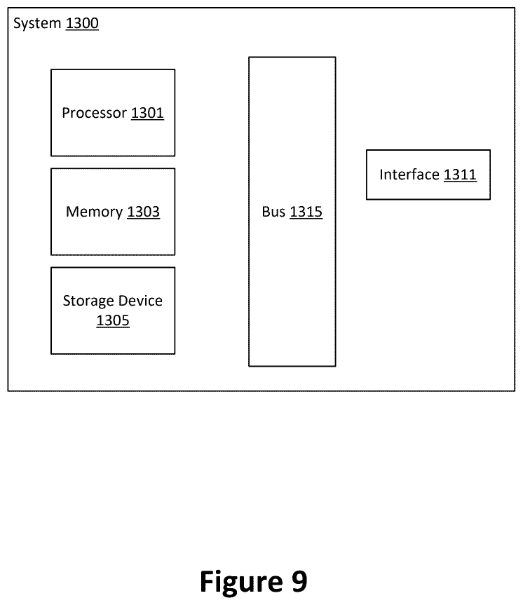

FIG. 9 illustrates one example of a computing device. According to various embodiments, a system 900 suitable for implementing embodiments described herein includes a processor 901, a memory module 903, a storage device 905, an interface 911, and a bus 915 (e.g., a PCI bus or other interconnection fabric.) System 900 may operate as variety of devices such as an application server, a database server, or any other device or service described herein. Although a particular configuration is described, a variety of alternative configurations are possible. The processor 901 may perform operations such as those described herein. Instructions for performing such operations may be embodied in the memory 903, on one or more non-transitory computer readable media, or on some other storage device. Various specially configured devices can also be used in place of or in addition to the processor 901. The interface 911 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
maintaining, via a computing system implemented using a database system, a database storing metadata describing a plurality of features associated with the computing system, the metadata being processable to cause the features to be rendered in a plurality of different user experiences;
automatically causing related features to be included in a setup provided to an authorized administrator affiliated with an organization implementing the computing system based on attributes of the organization, usage patterns of users affiliated with the organization, and/or one or more target markets for business of the organization;
causing, using the metadata, a user interface to be displayed on a device of the authorized administrator, the user interface being associated with a first one of the different user experiences, the user interface configurable to allow the authorized administrator to enable a plurality of sets of features on behalf of the organization;
receiving, from the authorized administrator via the user interface, a request to enable a first set of features from the plurality of sets of features; and
causing, based on the request, the first set of features to be enabled for users associated with the organization.

2. The method of claim 1, wherein the metadata corresponding to a particular feature includes capabilities, customization options, licensing information, and status of the particular feature.

3. The method of claim 2, wherein the metadata describes dependencies of the particular feature with respect to other features.

4. The method of claim 1, further comprising:
causing rendering of, in association with the plurality of sets of features, usage information associated with the plurality of sets of features.

5. The method of claim 1, wherein the user experiences include a web application, a native mobile application, a hybrid application, and/or a Large Language Model (LLM) chat interface.

6. (canceled)

7. The method of claim 1, further comprising:
automatically recommending and explaining in the setup, via an LLM chat interface, features to the authorized administrator based on data associated with the organization.

8. A computing system implemented using a server system, the computing system comprising:
one or more processors; and
a non-transitory computer readable medium storing instructions, which when executed, cause the one or more processors to:
maintaining a database storing metadata describing a plurality of features associated with the computing system, the metadata being processable to cause the features to be rendered in a plurality of different user experiences;
automatically cause related features to be included in a setup provided to an authorized administrator affiliated with an organization implementing the computing system based on attributes of the organization, usage patterns of users affiliated with the organization, and/or one or more target markets for business of the organization;
cause, using the metadata, a user interface to be displayed on a device of the authorized administrator, the user interface being associated with a first one of the different user experiences, the user interface configurable to allow the authorized administrator to enable a plurality of sets of features on behalf of the organization;
receive, from the authorized administrator via the user interface, a request to enable a first set of features from the plurality of sets of features; and
cause, based on the request, the first set of features to be enabled for users associated with the organization.

9. The computing system of claim 8, wherein the metadata corresponding to a particular feature includes capabilities, customization options, licensing information, and status of the particular feature.

10. The computing system of claim 9, wherein the metadata describes dependencies of the particular feature with respect to other features.

11. The computing system of claim 8, wherein the non-transitory computer readable medium storing instructions, which when executed, further cause the one or more processors to:
cause rendering of, in association with the plurality of sets of features, usage information associated with the plurality of sets of features.

12. The computing system of claim 8, wherein the user experiences include a web application, a native mobile application, a hybrid application, and/or a Large Language Model (LLM) chat interface.

13. (canceled)

14. The computing system of claim 8, wherein the non-transitory computer readable medium storing instructions, which when executed, further cause the one or more processors to: automatically recommend and explain in the setup, via an LLM chat interface, features to the authorized administrator based on data associated with the organization.

15. A computer program product comprising non-transitory computer-readable program code capable of being executed by one or more processors when retrieved from a non-transitory computer-readable medium, the program code comprising instructions configurable to cause the one or more processors to perform a method comprising:
maintaining, via a computing system implemented using a database system, a database storing metadata describing a plurality of features associated with the computing system, the metadata being processable to cause the features to be rendered in a plurality of different user experiences;
automatically causing related features to be included in a setup provided to an authorized administrator affiliated with an organization implementing the computing system based on attributes of the organization, usage patterns of users affiliated with the organization, and/or one or more target markets for business of the organization;
causing, using the metadata, a user interface to be displayed on a device of the authorized administrator affiliated, the user interface being associated with a first one of the different user experiences, the user interface configurable to allow the authorized administrator to enable a plurality of sets of features on behalf of the organization;
receiving, from the authorized administrator via the user interface, a request to enable a first set of features from the plurality of sets of features; and
causing, based on the request, the first set of features to be enabled for users associated with the organization.

16. The computer program product of claim 15, wherein the metadata corresponding to a particular feature includes capabilities, customization options, licensing information, and status of the particular feature.

17. The computer program product of claim 16, wherein the metadata describes dependencies of the particular feature with respect to other features.

18. The computer program product of claim 15, the method further comprising:
causing rendering of, in association with the plurality of sets of features, usage information associated with the plurality of sets of features.

19. The computer program product of claim 15, wherein the user experiences include a web application, a native mobile application, a hybrid application, and/or a Large Language Model (LLM) chat interface.

20. (canceled)

21. The computer program product of claim 15, the method further comprising automatically recommending and explaining in the setup, via an LLM chat interface, features to the authorized administrator based on data associated with the organization.
